(19) United States
(12) Patent Application Publication
(10) Pub. No.: US 2014/0004742 A1
(43) Pub. Date: Jan. 2, 2014

(54) DRE/HDMI/IR PASS THROUGH CABLE

(71) Applicants: Kailash Mehta, Dayton, OH (US); Allen Sheff, (US)

(72) Inventor: Allen Sheff, Cincinnati, OH (US)

(21) Appl. No.: 13/930,622

(22) Filed: Jun. 28, 2013

Related U.S. Application Data
(60) Provisional application No. 61/666,230, filed on Jun. 29, 2012.

(51) Int. Cl. H01R 11/00; H01B 13/00

(52) U.S. Cl. CPC H01R 11/00; H01B 13/00
USPC 439/623; 29/825

(57) ABSTRACT

DRE/HDMI/IR Pass through cable that delivers a crisp, clear audio/video signal. The illustrated cable offers the same baseline performance as a High Speed HDMI Cable, plus an additional, dedicated data channel, known as the HDMI Ethernet Channel, for device networking. The HDMI and the HDMI Ethernet Channel are extruded together to form a one piece cable structure rather than the current two piece cable structure available in the market. This extrusion may, for example, be executed through what is referred to in the art as a Siamese-type extrusion method.

### CROSS REFERENCE TO RELATED APPLICATIONS

This application claims the benefit of U.S. Provisional Application Ser. No. 61/666,230 filed Jun. 29, 2012.

### BRIEF DESCRIPTION OF THE DRAWINGS

FIGS. 1-4 illustrate a DRE/HDMI/IR Pass through cable.

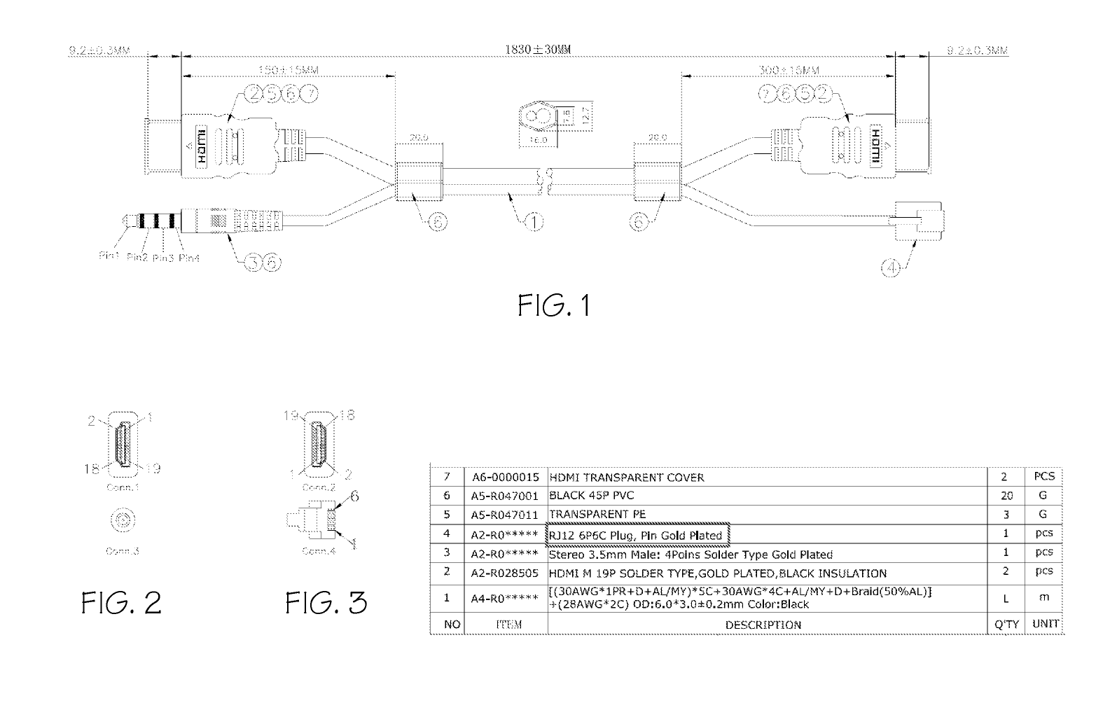

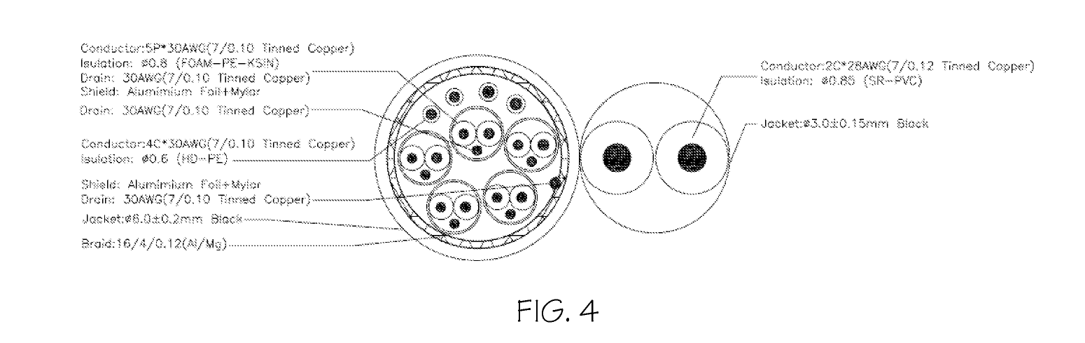

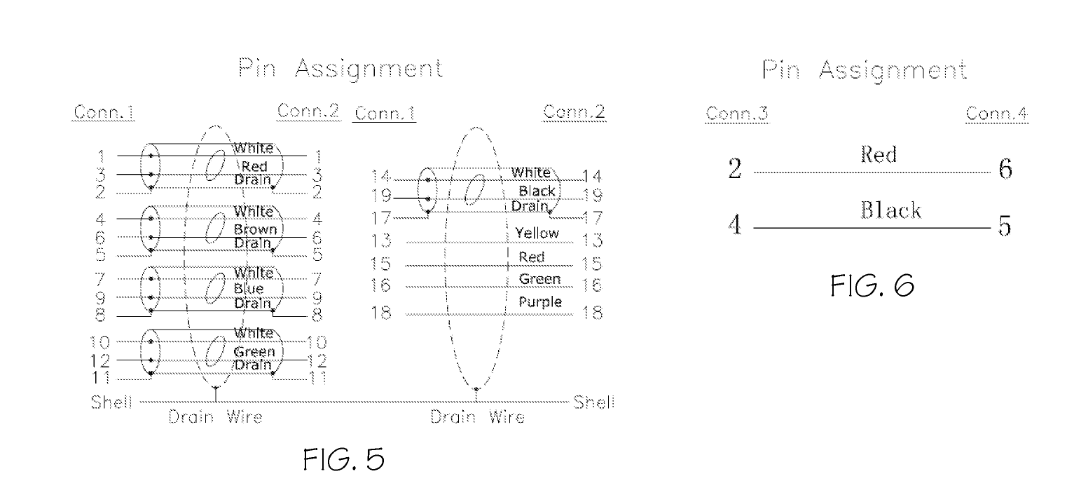

### DETAILED DESCRIPTION

The attached drawings illustrate a DRE/HDMI/IR Pass through cable that delivers a crisp, clear audio/video signal. The illustrated cable offers the same baseline performance as a High Speed HDMI Cable, plus an additional, dedicated data channel, known as the HDMI Ethernet Channel, for device networking. The HDMI and the HDMI Ethernet Channel are extruded together to form a one piece cable structure rather than the current two piece cable structure available in the market. This extrusion may, for example, be executed through what is referred to in the art as a Siamese-type extrusion method.

The illustrated design adds to the durability and integrity of the cable. As is illustrated, the cable comes with special mold blocks on each end to prevent separation from an RJ12 to 3.5 mm stereo cable and is presented with fully molded nickel-plated connectors to provide excellent strain relief and durable use. This configuration allows for ease of installation and an esthetically pleasing look and dependability. The illustrated configuration also uses 28 AWG silver satin wire for an excellent picture quality.

The illustrated cable has gold-plated connectors for clearer communication while the heavy-duty PVC jacket protects the cable's integrity. The Gold-plated connectors ensure long-lasting, dependable connections while the PVC jacket adds flexibility and durability. The fully molded connectors provide excellent strain relief. The cable construction therefore, provides a much better and a clean 1080 p picture and durability and integrity required by the industry.

Having described the subject matter of the present disclosure in detail and by reference to specific embodiments thereof, it is noted that the various details disclosed herein should not be taken to imply that these details relate to elements that are essential components of the various embodiments described herein, even in cases where a particular element is illustrated in each of the drawings that accompany the present description. Rather, the claims appended hereto should be taken as the sole representation of the breadth of the present disclosure and the corresponding scope of the various inventions described herein. Further, it will be apparent that modifications and variations are possible without departing from the scope of the invention defined in the appended claims. More specifically, although some aspects of the present disclosure are identified herein as preferred or particularly advantageous, it is contemplated that the present disclosure is not necessarily limited to these aspects.

What is claimed is:

1. A cable substantially as illustrated and described herein.

2. A cable including one or more of the novel features illustrated and described herein.

3. A method of manufacturing a cable, said method substantially as illustrated and described herein.

4. A method of manufacturing a cable, said method including one or more of the novel features illustrated and described herein.
